(19) United States
(12) Patent Application Publication
(10) Pub. No.: US 2012/0143616 A1
(43) Pub. Date: Jun. 7, 2012

(54) SYSTEM FOR AND METHOD OF TRANSACTION MANAGEMENT

(75) Inventors: Mohammad PULAK, Richardson, TX (US); Sayeed MAHMUD, Carrollton, TX (US); Kamal Navindra NAJ, Arlington, VA (US); Arun Kumar JINDE, Irving, TX (US)

(73) Assignee: Verizon Patent and Licensing, Inc., Basking Ridge, NJ (US)

(21) Appl. No.: 12/962,418

(22) Filed: Dec. 7, 2010

(51) Int. Cl. G06Q 10/00

(52) U.S. Cl. 705/1.1

(57) ABSTRACT

A system for and method of transaction management may include receiving, via a network, an indication of a transaction error and determining, using electronically stored transaction rules and data, a classification of the transaction error based at least in part on the received indication of the transaction error. The method may comprise presenting a transaction associated with the error to a user for correction in the event the error is classified as a human error. The method may also comprise presenting the transaction associated with the error to a user, in the event an error is classified as an external system error, to perform at least one of: retracting an offer associated with the transaction, and changing an offer associated with the transaction. The method may include providing a notification to an external system in the event the error is classified as an external system error.

### BACKGROUND INFORMATION

Transactions such as customer orders can encounter problems in processing. Problems with orders and other transactions cause customer dissatisfaction and lost revenue. Large volume systems interfacing with other systems increase the complexity and likelihood of a transaction processing problem. Quickly identifying and resolving transaction processing problems with a large number of transactions is challenging.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a system for transaction management, according to a particular embodiment;

FIG. 2 is a block diagram of a module for performing transaction management, according to a particular embodiment;

FIG. 3 depicts a method for transaction management, according to a particular embodiment; and

FIG. 4 depicts an interface for transaction processing, according to a particular embodiment.

FIG. 5 depicts an interface for editing transactions, according to a particular embodiment.

FIG. 6 depicts an interface for confirmation of transaction modifications, according to a particular embodiment.

FIG. 7 depicts an interface for transaction management overview, according to a particular embodiment.

FIG. 8 depicts an interface for transaction reassignment, according to a particular embodiment.

FIG. 9 depicts an interface for transaction reminder generation, according to a particular embodiment.

FIG. 10 depicts an interface for managing offers, according to a particular embodiment.

FIG. 11 depicts an interface for displaying errors associated with offers, according to a particular embodiment.

### DETAILED DESCRIPTION OF PREFERRED EMBODIMENTS

According to some embodiments, transaction management may include automatically trapping and identifying errors. Errors may be classified and automatically handled according to electronically stored rules and data. Classification of errors may include, for example, operator or user error, internal system error, external system error (e.g., billing system error, provisioning system error, marketing system error, etc.), and communications error (e.g., network error). Depending on a classification of an error associated with a transaction different actions may be assigned. For example, user or operator errors may cause a user interface to be displayed to a user (e.g., an operator who entered an order associated with the transaction) allowing the user to correct data entry errors and omissions. Other errors may cause automatic actions to occur such as resubmission of a transaction for processing. Electronically stored rules and data may be modified (e.g., by a supervisor) allowing handling of errors to adapt to changing conditions and systems.

According to one or more embodiments, the method may comprise receiving, via a network, an indication of a transaction error and determining, using electronically stored transaction rules and data, a classification of the transaction error based at least in part on the received indication of the transaction error. The method may comprise presenting a transaction associated with the error to a user for correction in the event the error is classified as a human error. The method may also comprise presenting the transaction associated with the error to a user, in the event an error is classified as an external system error, to perform at least one of: retracting an offer associated with the transaction, and changing an offer associated with the transaction. The method may include providing a notification to an external system in the event the error is classified as an external system error.

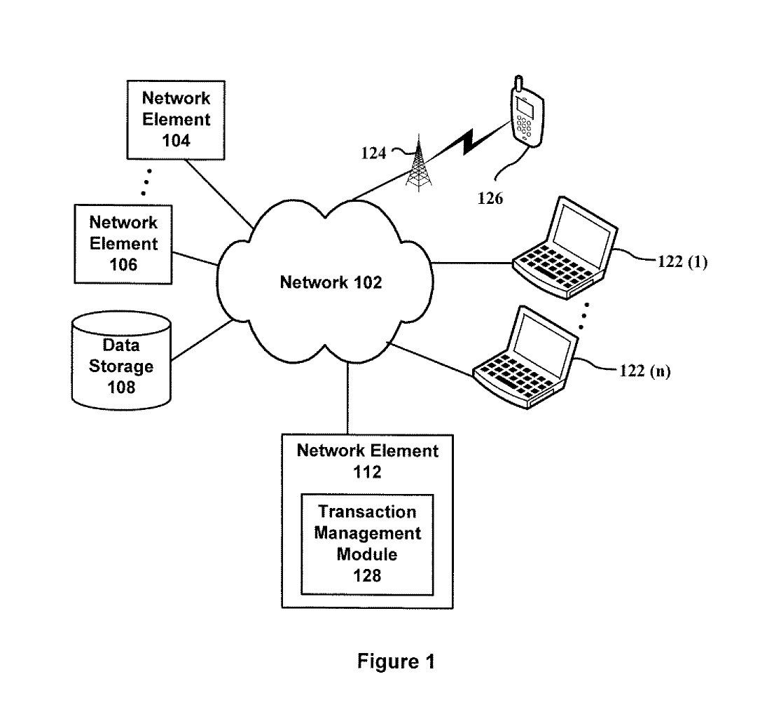

FIG. 1 is a schematic diagram illustrating a system for transaction management, according to a particular embodiment. As illustrated, network 102 may be communicatively coupled with one or more devices including network element 104, network element 106, data storage 108, and network element 112. Network element 112 may contain transaction management module 128. Other devices may communicate with network 102 via one or more intermediary devices, such as wireless device 126 via transmitter/receivers 124.

The description below describes network elements, computers, and components of a system of and method for transaction management that may include one or more modules. As used herein, the term “module” may be understood to refer to non-transitory executable software, firmware, hardware, and various combinations thereof. Modules however are not to be interpreted as software which is not implemented on hardware, firmware, or recorded on a processor readable recordable storage medium (i.e., modules are not software per se). It is noted that the modules are exemplary. The modules may be combined, integrated, separated, and duplicated to support various applications. Also, a function described herein as being performed at a particular module may be performed at one or more other modules and by one or more other devices instead of or in addition to the function performed at the particular module. Further, the modules may be implemented across multiple devices and other components local or remote to one another. Additionally, the modules may be moved from one device and added to another device, and may be included in both devices.

Network 102 may be one or more of a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.l, 802.11n and 802.11g or any other wired or wireless network for transmitting and receiving a data signal. In addition, network 102 may include, without limitation, telephone line, fiber optics, IEEE Ethernet 802.3, a Wide Area Network (“WAN”), a Local Area Network (“LAN”), or a global network such as the Internet. Also, network 102 may support, an Internet network, a wireless communication network, a cellular network, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as a single network, it should be appreciated that according to one or more embodiments, network 102 may comprise a plurality of interconnected networks, such as, for example, a service provider network, the Internet, a broadcaster's network, a cable television network, a corporate network, and a home network.

Network elements 104, 106, 112, and data storage 108 may transmit and receive data to and from network 102 such as, for example, VOIP data, videoconferencing data, multimedia data, and other data. The data may be transmitted and received utilizing a standard telecommunications protocol or a standard networking protocol. For example, one embodiment may utilize Session Initiation Protocol (“SIP”). In other embodiments, the data may be transmitted and received utilizing H.323. In yet other embodiments, data may also be transmitted and received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet (“TCP/IP”) Protocols, or other protocols and systems suitable for transmitting and receiving broadcast or parallel search data. Data may be transmitted and received wirelessly or may utilize cabled network or telecom connections such as an Ethernet RJ45/Category 5 Ethernet connection, a fiber connection, a traditional phone wireline connection, a cable connection or other wired network connection. Network 102 may use standard wireless protocols such as, for example, IEEE 802.11a, 802.11b 802.11g, and 802.11n. Network 102 may also use protocols for a wired connection, such as IEEE Ethernet 802.3.

Wireless device 126 may communicate with network 102 via transmitter/receiver 124. Transmitter/receiver 124 may be a repeater, microwave antenna, cellular tower, or other network access device capable of providing connectivity between to different network media. Transmitter/receiver 124 may be capable of sending or receiving signals via a mobile network, a paging network, a cellular network, a satellite network or a radio network. Transmitter/receiver 124 may provide connectivity to one or more wired networks and may be capable of receiving signals on one medium such as a wired network and transmitting the received signals on a second medium such as a wireless network.

Wireless device 126 may be a wireline phone, a cellular phone, a mobile phone, a satellite phone, a Personal Digital Assistants (PDA), a computer, a handheld MP3 player, a handheld video player, a personal media player, a gaming devices, or other devices capable of communicating with network 102 via transmitter/receivers 124. According to some embodiments, wireless device 126 may be use Voice Over IP (“VOIP”) to provide one or more services.

Network clients 122 may be desktop computers, a laptop computers, servers, personal digital assistants, or other computers capable of sending and receiving network signals. Network clients 122 may use a wired or wireless connection. In one or more embodiments, network clients 122 may connect directly to network 102 or via other network connectivity devices. According to one or more embodiments, network clients 122 using a wireless connection may authenticate with a network using Wired Equivalent Privacy, Wi-Fi Protected Access or other wireless network security standards.

Network elements 104, 106, 112, and data storage 108 may include one or more processors for recording, transmitting, receiving, and storing data. Although network elements and data storage 108 are depicted as individual elements, it should be appreciated that the contents of one or more of a network element and data storage 108 may be combined into fewer or greater numbers of devices and may be connected to additional devices not depicted in FIG. 1. Furthermore, the one or more devices may be local, remote, or a combination thereof to a first network element and data storage 108.

Network elements 104 and 106 may be one or more servers (or server-like devices such as, for example, a card or component in a larger host), such as a Session Initiation Protocol (“SIP”) server. Network elements 104 and 106 may include one or more processors for recording, transmitting, receiving, and storing data. Network elements 104 and 106 may be servers of a service provider, the Internet, a broadcaster, a cable television network, or another media provider. According to some embodiments network element 104 may be a Domain Name Server (DNS), a gateway, or other network infrastructure. According to some embodiments, network elements 104 and 106 may be servers which may provide different transaction processing services. According to some embodiments, network element 104 may be a billing system and network element 106 may be a network provisioning system. Network elements 104 and 106 may also facilitate or handle network transactions, electronic payment, and other electronic order processing actions, according to some embodiments.

Network elements 104 and 106 may provide Application Programming Interfaces (“APIs”), interface tables, Remote Procedure Calls (“RPCs”), web services, Extensible Markup Language (“XML”) based interfaces, Simple Object Access Protocol (“SOAP”) based interfaces, Common Object Request Broker Architecture (“CORBA”) and other interfaces for sending or receiving media searches, preferences or other information.

Data storage 108 may be network accessible storage and may be local, remote, or a combination thereof to network elements 104 and 106. Data storage 108 may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage 108 may be a database, such as an Oracle database, a Microsoft SQL Server database, a DB2 database, a MySQL database, a Sybase database, an object oriented database, a hierarchical database, or other database. Data storage 108 may utilize flat file structures for storage of data (e.g., XML).

According to some embodiments, data storage 108 may contain rules and data for handling errors such as transaction errors. Rules may be one or more of organized, categorized, indexed, and grouped according to different criteria. For example, some rules may be indexed by an error identifier and grouped by an error type. Error types may include, but are not limited to: human errors or user errors, internal system errors, external system errors, and communication errors.

Data storage 108 may contain mappings associating errors with one or more rules to apply. For example, an error may be associated with an indicator of an error type or classification. An error indicator may include one or more of an error number, an error name, an error symptom, and an error originating system. Data storage 108 may contain a mapping from an error indicator to a rule or response. As an example, an error indicator may correspond to a user error. Data storage 108 may map a user error indicator to a rule causing a notification to be displayed in a user interface which requests correction of a transaction associated with the error. As another example, error indicators associated with a communication error may be mapped to a rule causing resubmission of a transaction. Other error data and associated rules may also be stored in data storage 108.

Data storage 108 may be used to other data including escalation and notification rules and system status data. Escalation and notification rules may be used to provide escalation of an error when the error meets one or more specified criteria. For example, an error may be escalated to a higher level (e.g., a supervisor) or given a higher priority if it meets one or more criteria. Criteria may include a customer support level or a customer priority, a dollar value associated with a transaction, a transaction creation date, an error date, an error severity indicator, a date since last action taken associated with the transaction, an error type, and an error identifier. Notification rules may be used to provide escalation notifications (e.g., notifying a user that a transaction error has been escalated, notifying a customer that a transaction error has been escalated, notifying a supervisor that a transaction sent to him has been escalated from one of his/her employees, etc.) Notification rules may also provide confirmations of actions, reminders, system status information, and other transaction or system information.

According to some embodiments, data storage 108 may contain transaction data including one or more work queues, transactions associated with work queues, status data associated with transactions, privilege data or access rights associated with transaction management functionality, and transaction management functionality data. Transaction management functionality data may include acceptable modifications associated with a transaction which may depend on one or more criteria (e.g., transaction type, transaction status, associated error(s), and user access privileges). Transaction data may include sales codes, offer codes, promotion codes, discounts, terms, limitations, expiration dates, and restrictions. Transaction management functionality may limit or control the mapping of sales codes, offer codes, promotions, discounts, and other offer terms to a transaction.

Data storage 108 may contain tables or other data structures including, but not limited to, a fallout error table, an error type table, a process rule table, and a message table. According to some embodiments, upon receiving an error in a fallout table one or more process rules may be triggered. The one or more process rules may attempt to match a message to the error message based on error message text, error codes, or other error attributes or identifiers. If a message corresponding to an error is identified, the message may be presented to a user via one or more user interfaces. According to some embodiments, if an errors is received in a fallout table a notification may be generated (e.g., an email message to a system administrator). The notification may allow a user to provide at least one of a rule or a message associated with the error. For example, an administrative user or a system developer may be alerted about an error in a fallout table. The user may identify the error and may provide a message in a message table so that subsequent occurrences of this error may be handled via a notification or message to a user.

According to one or more embodiments, network element 112 may be a server, a host, or another network element, supporting one or more clients. Network element 112 may contain transaction management module 128. Transaction management module 128 may support one or more network clients (e.g., wireless device 126 and network clients 122(1) to (n)).

The various components of system 100 as shown in FIG. 1 may be further duplicated, combined and integrated to support various applications and platforms. Additional elements may also be implemented in the systems described above to support various applications.

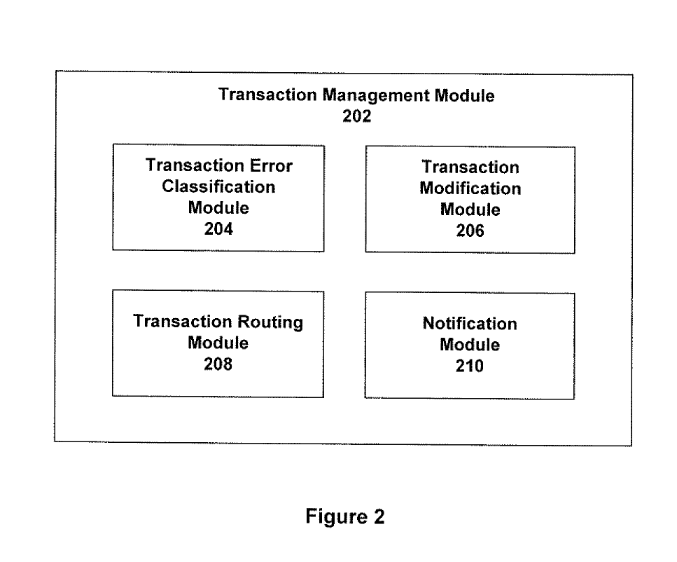

FIG. 2 is a block diagram of a hardware component of the system transaction management, according to a particular embodiment; according to a particular embodiment. As illustrated, the transaction management module 202 may contain one or more components including transaction error classification module 204, transaction modification module 206, transaction routing module 208, and notification module 210. Although transaction management module 202 is depicted as a single module, functionality or modules of transaction management module 202 may be located on a single device or distributed across a plurality of devices including one or more centralized servers and one or more end user devices. According to some embodiments, transaction management module 202 may be implemented as transaction management module 128 of FIG. 1. One or more portions of transaction management module 202 may be communicatively coupled with or integrated with one or more of network element 112, wireless device 126, and network clients 122.

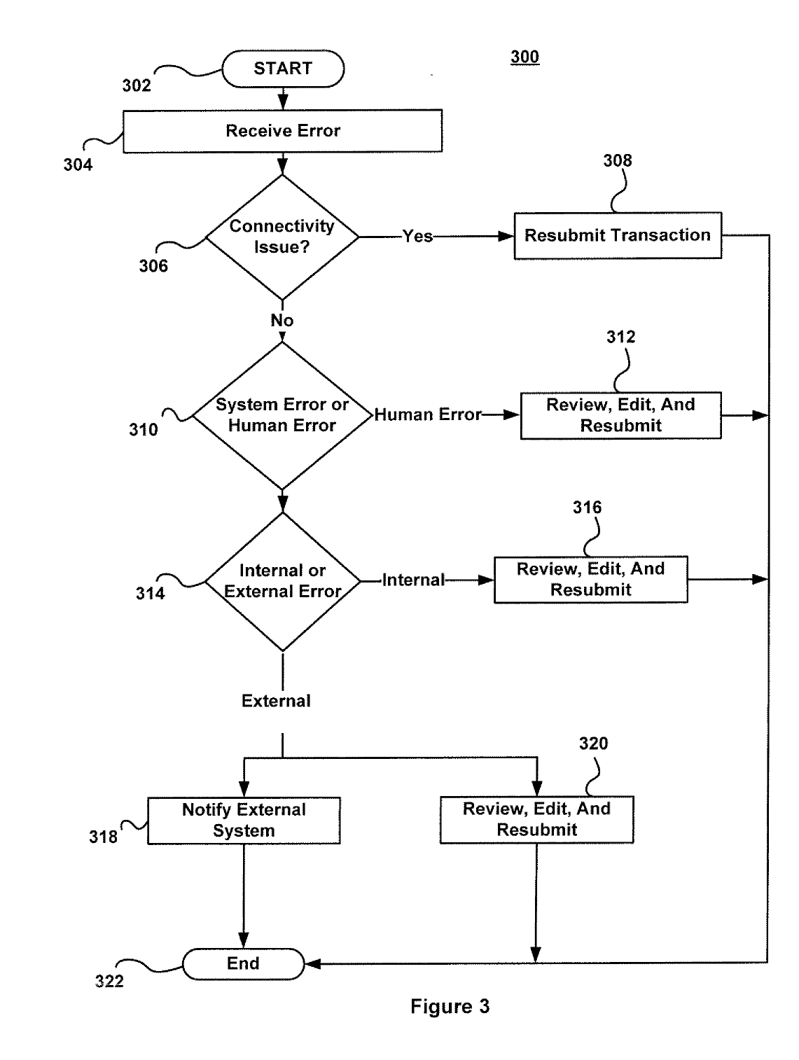

FIG. 3 depicts a method for transaction management, according to a particular embodiment. At block 302, the method 300 for transaction management may begin.

At block 304, a transaction error may be received. According to some embodiments, a publish and subscribe architecture may be used to receive errors via a queue. Errors may also be trapped and exception handling may provide notifications. According to some embodiments, a database table, a workflow queue, an API, a web service, or another data structure may be monitored, polled, or utilized to identify an error.

According to some embodiments, transaction management module 128 of FIG. 1 or transaction management module 202 of FIG. 2 may receive and classify errors. Errors may be received by querying transaction data from one or more systems. Errors may be received by monitoring transaction status information and system status information. A received error may be parsed and classified. Parsing of an error message or error code may identify one or more transaction details (e.g., a transaction type, a current transaction status, a sales code, transaction terms, etc.). One or more of parsed error codes, messages, and corresponding transactions may be matched or compared against stored error mappings. For example, data storage 108 of FIG. 1 may be queried using a parsed and classified error to determine one or more rules to apply to a transaction associated with an error. One or more transaction details may be validated (e.g., a marketing server may be queried to validate an offer code is valid). One or more rules may be applied to classify an error. Error classifications may include, but are not limited to: human errors or user errors, internal system errors, external system errors, and communication errors.

At block 306, it may be determined whether the error is associated with a connectivity issue. For example, a received error may be parsed and it may be determined that a network error occurred. A timeout message may be received or no response may be received after a specified period of time. If it is determined that a received error is associated with a connectivity issue, the method 300 may continue at block 308. If the received error is not associated with a connectivity issue, the method 300 may continue at block 310.

At block 308, a transaction may be resubmitted. According to some embodiments, resubmission may be immediately, after a specified period of time, or after receiving an indication that the communication problem has been resolved. According to some embodiments, one or more resources including, but not limited to, network bandwidth and external system resources (e.g., CPU and memory), may be monitored and resubmission of a response may be based on available resources and a priority associated with a transaction. According to some embodiments, some errors may be queued so that they may be manually resubmitted.

At block 310, it may be determined whether an error is a system error or a human error. A received error may be parsed and one or more portions of an error may be mapped to a system error or a human error. An error associated with bad data in one or more fields may be classified as a human or operator error. A transaction associated with an error may be automatically parsed and one or more fields validated to identify invalid data (e.g., an invalid area code). In some embodiments, a human error may be mapped to a rule notifying an operator of the error and requesting correction of an associated transaction.

If an error is determined to be a human error, the method 300 may continue at block 312. If an error is determined to be a system error, the method 300 may continue at block 314.

At block 312, a user interface may be provided for handling an error associated with a transaction. The transaction associated with the error may be assigned to an operator queue or in some embodiments it may already be in a queue of a transaction creator and it may remain there for correction. A user or operator associated with a work queue may receive a notification or a message may be displayed in a user interface. The notification or message may provide error details and request correction of or verification of one or more items or fields of a transaction. The notification may be associated with or contain transaction details of a transaction associated with the error. Human errors may include, but are not limited to, incorrect data, incomplete data, expired sales codes, application of too large of a discount to a transaction, and application of incompatible offers to a transaction. A user may review a transaction, edit one or more portions (e.g., a telephone number, an order creation date, an order number, and a due date), and resubmit a transaction for processing. For example, a user may verify and correct one or more of a telephone number, an order creation date, an order number, and a due date.

At block 314, it may be determined whether an error is an internal error or an error in an external system. An error associated with one or more error codes may be classified as an external system error by mapping error codes, strings, or other indicators to a data structure (e.g., a table) of errors. An external system error may occur if an error is received from another system such as, for example, a billing system, a marketing system, or a network provisioning system. An external system error may be received, for example, a sales code is valid but a billing system has not received the sales code. External system errors may also occur if accounts are not found, customer information is not found, or other valid information is not found on an external system.

If an error is an internal error, a transaction may be assigned to a queue for debugging and specific handling and the method may continue at block 316. If an error is identified as an external error, the method 300 may continue at blocks 318 and 320.

At block 316, a user interface for transaction review and modification may be provided. One or more issues may be identified (e.g., an error in transaction management module 128 or data storage 108 of FIG. 1). Transaction processing logic and associated data may be modified (e.g., in data storage 108 of FIG. 1). The transaction may be reviewed, modified, and resubmitted.

At block 318, an external system or users associated with an external system (e.g., a system administrator or manager) may be notified.

At block 320, a user interface may be provided to review, modify, and resubmit a transaction. External system errors may be presented to a user along with a notification or message indicating the error. For example, a transaction may be presented in a user interface together with an error message indicating that a sales code caused an error. This may be due, for example, to an external system which may not contain proper marketing data. A transaction may be modified to provide transaction data compatible with a back end system (e.g., a promotion code present in a billing system, a user account present in a billing system, or a service type present in a provisioning system). Sales codes and other transaction terms entered by a user may be controlled and verified (e.g., a lookup may be performed against a table or data structure of valid sales codes). One or more rules may be applied to verify a transaction prior to resubmission (e.g., checking to see if incompatible offers are applied to a same transaction, if a discount is too high, if an inappropriate offer was applied). According to some embodiments, some transaction modifications may be routed for approval. A user interface may be provided allowing a user to retract an offer (e.g., remove a discount). A user may resubmit a modified transaction for processing. According to some embodiments, errors associated with an external system may be queued for resubmission and may be resubmitted without modification once an issue with an external system has been resolved.

According to some embodiments, a status of one or more external systems may be tracked to identify, prevent, and resolve external system errors. For example, a response time in processing or a timeout error occurring in one or more external systems may be observed. One or more transactions may be held in a queue for later submission when a processing load on an external system is lower or a response time on an external system is better. Orders may be prioritized according to one or more criteria (e.g., a customer support level or a customer priority, a dollar value associated with a transaction, a transaction creation date, an error date, an error severity indicator, a date since last action taken associated with the transaction, an error type, and an error identifier) and may be submitted for processing or control order processing according to one or more criteria.

At block 322, the method 300 may end.

According to some embodiments, additional transaction management functionality may be provided including escalation of errors, notifications to facilitate error handling, reassignment of error handling, and other error resolution and prevention measures.

Transaction errors may be escalated according to one or more specified criteria (e.g., a customer support level or a customer priority, a dollar value associated with a transaction, a transaction creation date, an error date, an error severity indicator, a date since last action taken associated with the transaction, an error type, and an error identifier). Escalation may cause an order to be reassigned to a manager or supervisor queue, may change a priority of an order in a queue, and may generate one or more notifications. Multiple levels of escalations may occur such as, for example, up tiers of a management hierarchy. A first level of escalation may occur after a first set of criteria are met (e.g., a first time period expires) and a second level of escalation may occur after a second set of criteria are met (e.g., expiration of a second subsequent time period or threat of account loss). One or more user interfaces may be provided for managing and viewing transactions, notifications, errors, system status, and other transaction management information.

A user interface and logic allowing reassignment of one or more transactions to another operator or user may also be provided. According to some embodiments, a user may require privileges to access a transaction reassignment user interface. For example, reassignment may be performed by a manager or a supervisor. A user with appropriate privileges such as, for example, a manager, may access an interface allowing viewing, query, and review of one or more other operators' transactions. A manager may identify one or more transaction errors which have not been resolved and may assign these transaction errors to a queue of a different operator. According to some embodiments, one or more transaction errors may automatically be reassigned to different operators according to one or more rules (e.g., workload balancing, error identifier, operator expertise, a customer associated with a transaction, a period of time since an error has occurred, etc.). A manager may also generate reminder notifications to one or more operators.

Notifications may be based on one or more specified criteria of a transaction. Criteria may include a customer support level or a customer priority, a dollar value associated with a transaction, a transaction creation date, an error date, an error severity indicator, a date since last action taken associated with the transaction, an error type, and an error identifier. Notification rules may be used to provide escalation notifications (e.g., notifying a user that a transaction error has been escalated, notifying a customer that a transaction error has been escalated, notifying a supervisor that a transaction sent to him has been escalated from one of his/her employees, etc.) Notification rules may also provide confirmations of actions, reminders, system status information, and other transaction or system information. Notification may be provided as a message on a user interface (e.g., a web page), as a recorded phone message, as an email, an SMS message, or by other electronic communication. Notifications may be generated automatically according to one or more criteria or may be generated manually.

According to some embodiments, some errors received or identified may be reassigned to a fallout queue. These errors may be unrecognized errors, complex errors, errors requiring special handling, or errors specified to be assigned to a fallout queue. A fallout queue may be managed via an electronic user interface by one or more operators who may perform one or more of modifying a transaction, resolving a system error, deleting a transaction, reassigning a transaction, escalating a transaction, and resubmitting a transaction. According to some embodiments, an error assigned to a fallout queue may be identified and rules may be implemented in data storage 108 of FIG. 1. Subsequent errors of a same type may not be assigned to a fallout queue and may be resolved automatically or by an operator based at least in part on implemented rules.

One or more users may have access privileges to modify stored rules and functionality (e.g., in data storage 108 of FIG. 1, transaction management module 128 of FIG. 1, and transaction management module 202 of FIG. 2) to control routing of errors, reassignment of transactions, notifications, and other transaction management functionality. Routing of errors may be changed based on a system load, changing system conditions, changing data (e.g., new sales codes, terms, or transaction types), and other conditions.

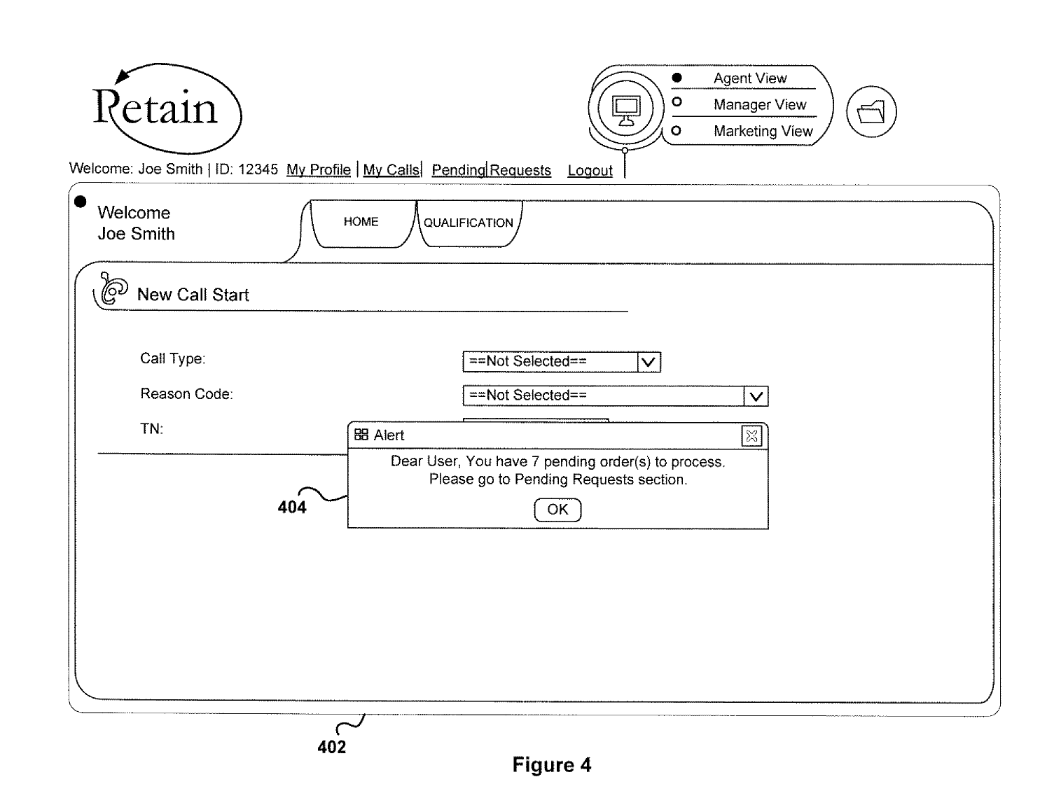

FIG. 4 depicts an interface for transaction processing, according to a particular embodiment. Interface 402 may be a welcome or a home screen for a transaction processing agent and may contain functionality allowing entry of a transaction. Notification 404 may provide summary information about pending transactions requiring attention. Interface 402 may also provide functionality for entering a new transaction. Interface 402 may provide access to additional functionality (e.g., qualification of a customer for a product or service based on location, product or service availability, and credit history). Interface 402 may also permit a user with appropriate privileges to switch a view or interface (e.g., agent view, manager view, and marketing view). Different views may provide access to different functionality and data.

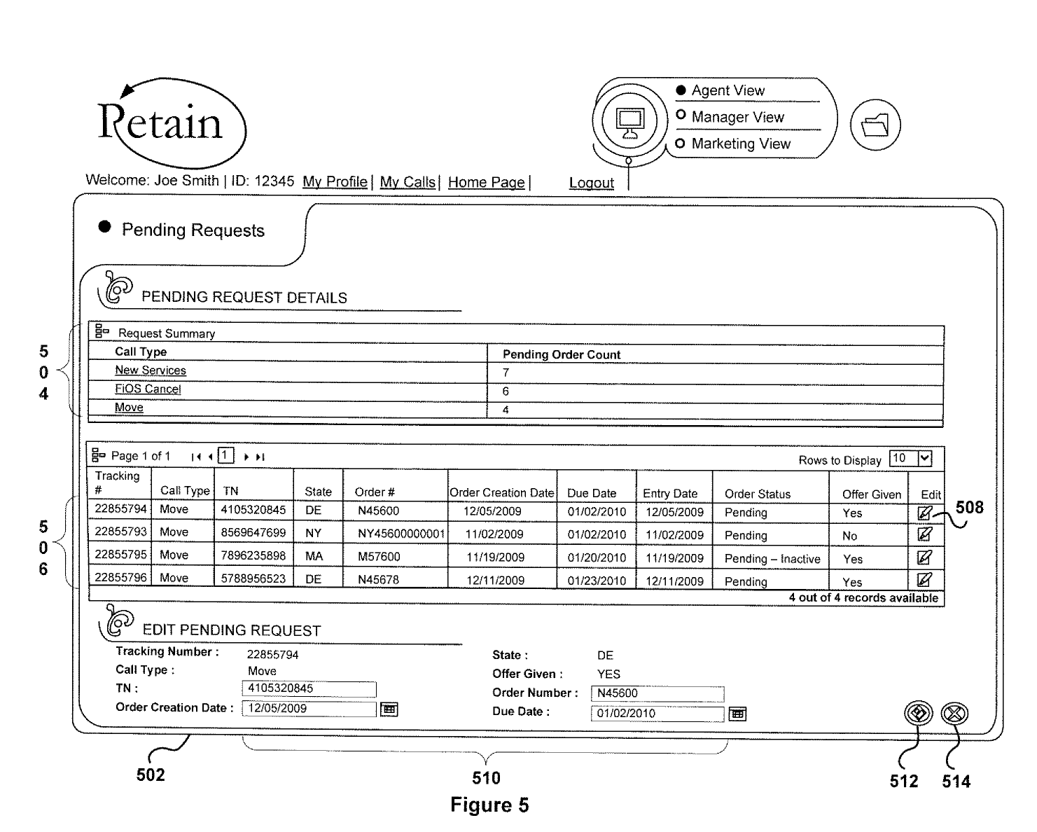

FIG. 5 depicts an interface for editing transactions, according to a particular embodiment. Interface 502 may contain transaction or request summary section 504 which may group transactions by type and provide a corresponding count. Clicking on a type of order in request summary section 504 may display detail section 506 providing transaction details for transactions of that type. For example, clicking on “Move” may display pending move transactions as illustrated in detail section 506. Clicking on edit control 508 for a particular transaction may display fields 510, one or more of which may be editable. For example, clicking on edit control 508 associated with transaction tracking number 22855794 may display the details associated with transaction tracking number 2285794. Certain fields such as, for example, telephone number, order creation date, order number, and due date may be editable. Logic may control which fields are editable based on an error associated with a particular transaction, access privileges, a transaction status, and other factors. Control 512 may save a modified transaction. Control 514 may cancel changes to a modified transaction.

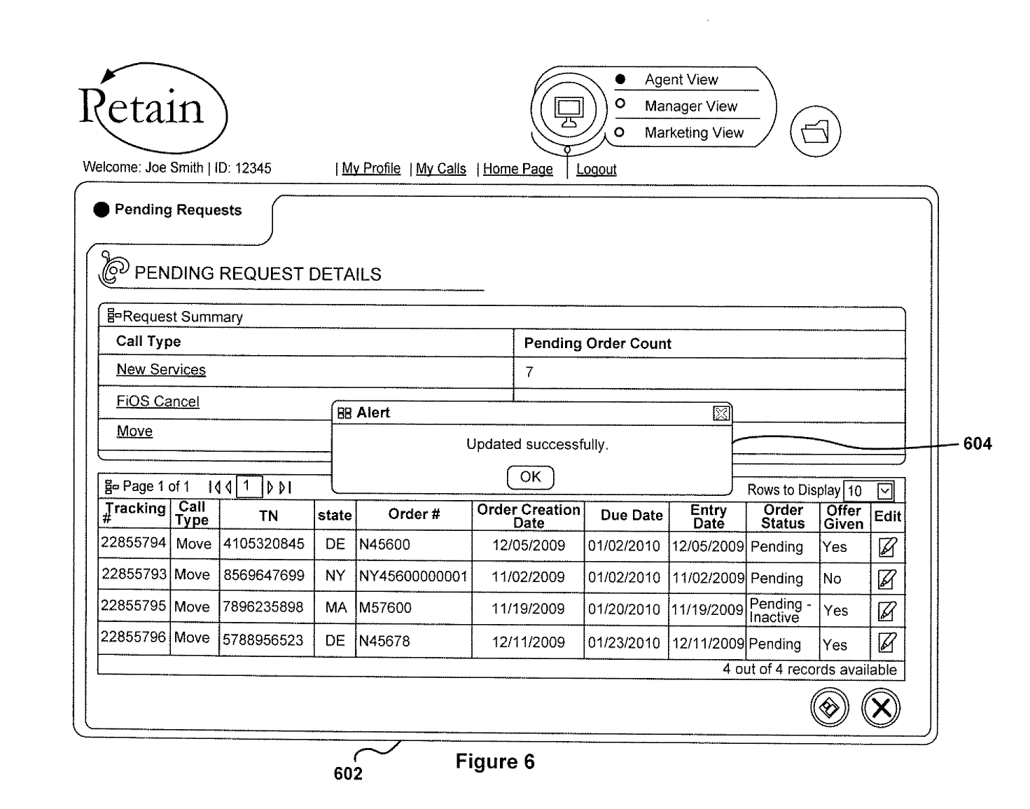

FIG. 6 depicts an interface for confirmation of transaction modifications, according to a particular embodiment. Interface 602 may display confirmation message 604 indicating that modifications have been saved.

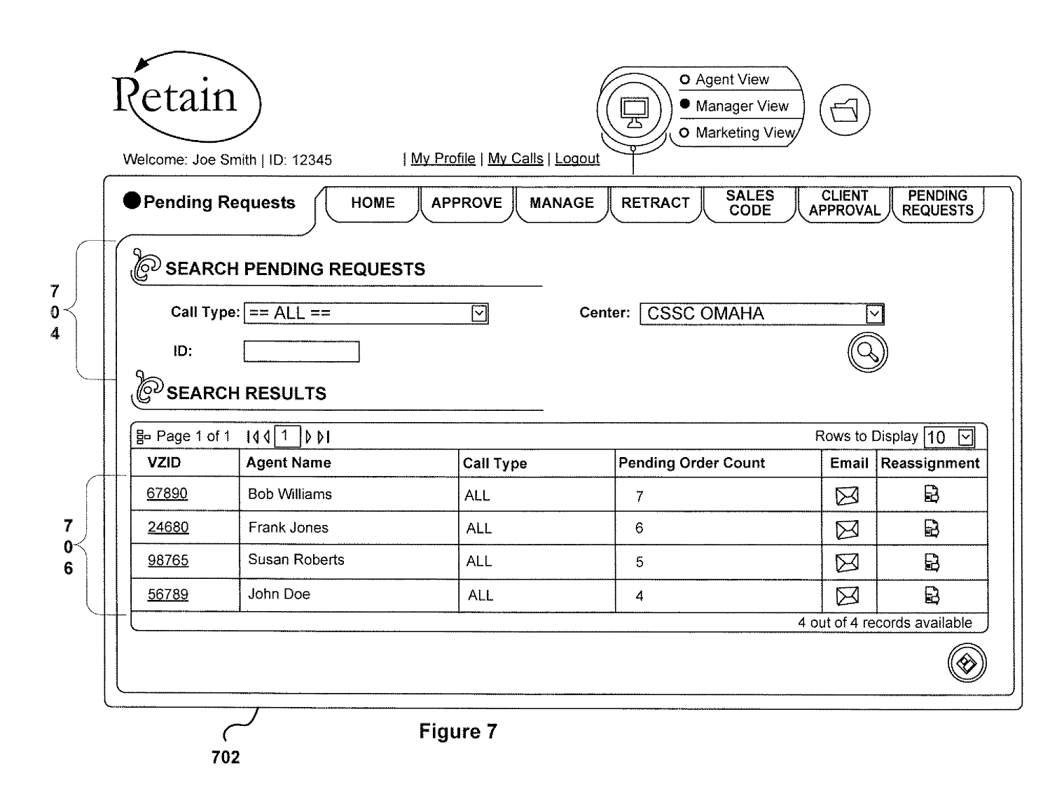

FIG. 7 depicts an interface for transaction management overview, according to a particular embodiment. Interface 702 may provide transaction search functionality section 704. According to some embodiments, search functionality may provide searching for a supervisor or other user with appropriate credentials. Searching may be performed on transactions by a type, responsible user id, transaction handling location, or other criteria. Results of a search may be displayed in results section 706. Interface 702 may also provide access to other functionality including, but not limited to, approval of transactions, retraction of offers made in transactions, modification and verification of sales codes, verification of client approval of a transaction, and other management functionality (e.g., escalation).

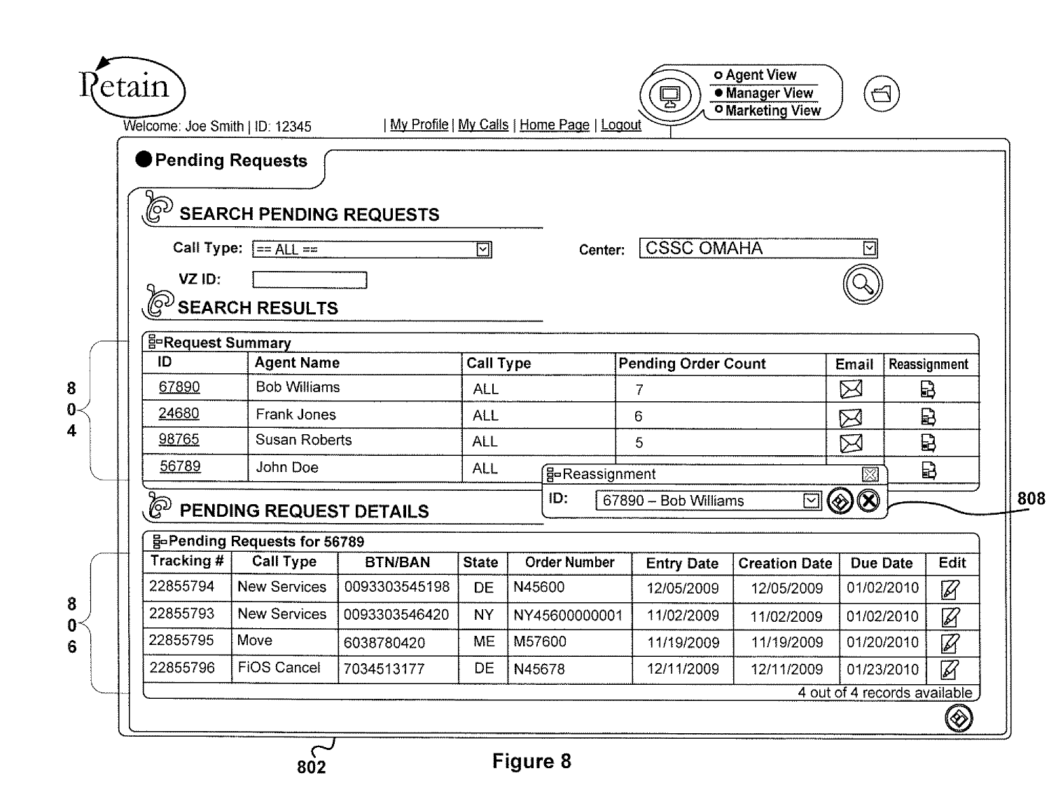

FIG. 8 depicts an interface for transaction reassignment, according to a particular embodiment. Interface 802 may display search results 804. According to some embodiments, search results 804 may group transactions by a user or agent responsible for the transactions. Search results 804 may provide additional functionality such as, for example, controls providing an ability to reassign one or more transactions from a first user to a second user. Additional controls may include a notification control which may automatically generate a reminder to a user from a supervisor about one or more pending transactions. Selecting or clicking on a search result of search results 804 may provide transactions details section 806. Transactions details section 806 may provide additional user interface controls and functionality such as, for example, an ability to bring up a transaction editing interface. A supervisor may be able to edit one or more transaction details of a subordinate's transactions.

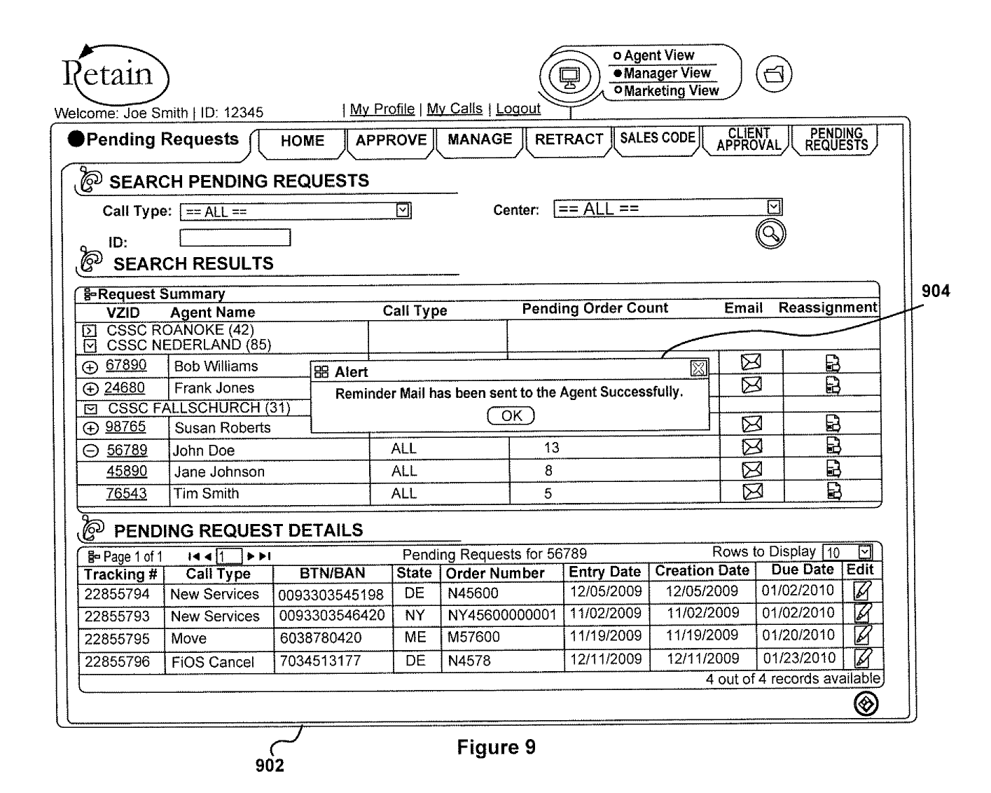

FIG. 9 depicts an interface for transaction reminder generation, according to a particular embodiment. Interface 902 may display reminder notification confirmation 904. Reminder notification confirmation 904 may verify that a reminder has been sent to an agent about one or more pending transactions. As depicted in FIG. 9, search results may be grouped (e.g., by call center). Search results may also be sorted.

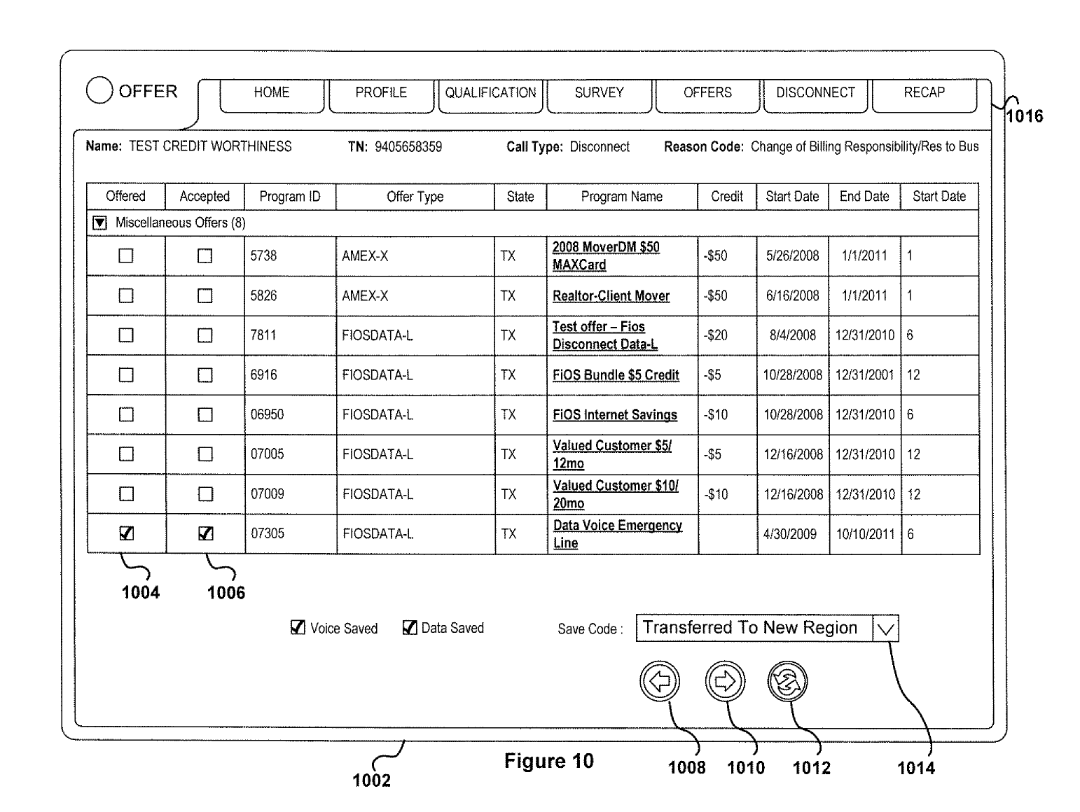

FIG. 10 depicts an interface for managing offers, according to a particular embodiment. As illustrated, interface 1002 may display details of a plurality of offers available for selection or currently selected for a current account. Interface controls 1004 and 1006 may allow offer and acceptance of one or more offers. Interface controls 1008 and 1010 may allow navigation across a plurality of accounts. Interface control 1012 may allow reloading or refreshing of an interface. Interface control 1014 may allow transaction status codes or save codes which may capture marketing information related to offers. Interface controls 1016 may provide navigational controls (e.g., tabs) providing access to other screens or interfaces including, but not limited to, a profile tab for an account profile, a qualification tab for qualifying an account for an offer, a survey tab providing access to a survey interface for capturing marketing information; an offers tab for identifying offers, a disconnect tab for disconnecting services, and a recap tab.

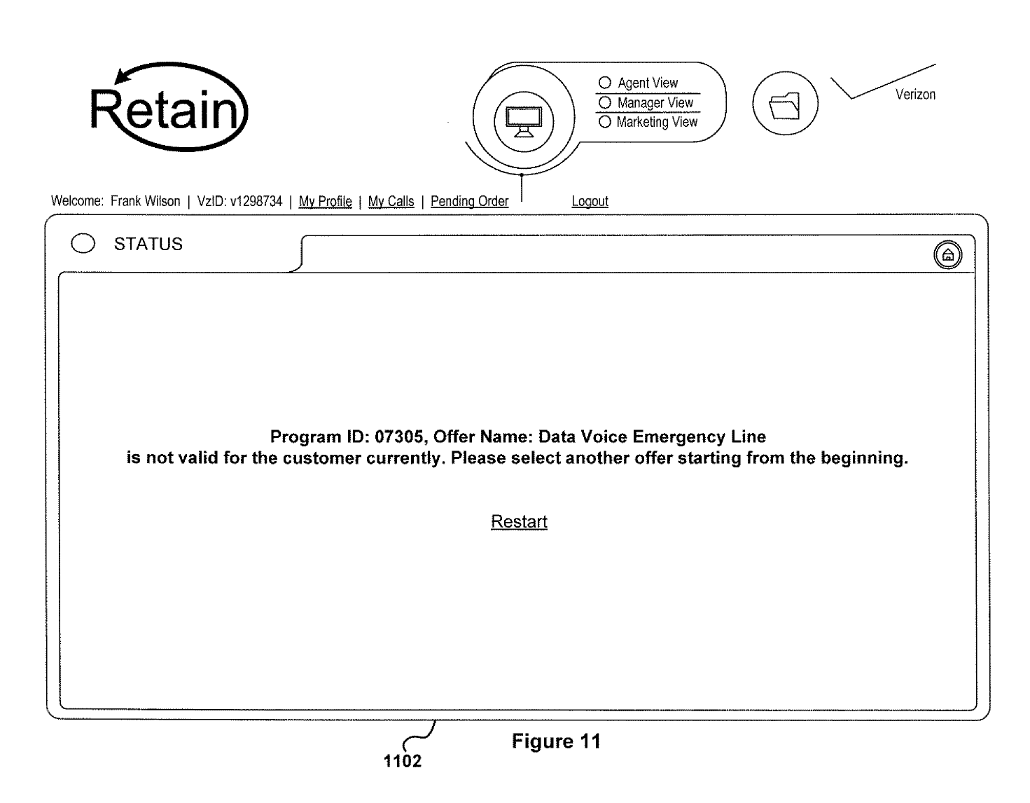

FIG. 11 depicts an interface for displaying errors associated with offers, according to a particular embodiment. As illustrated, interface 1102 may provide offer status information and error messages. Interface 1102 may allow an interface control (e.g., a link) for modifying or correcting offer errors.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A computer-implemented method, comprising:
receiving, via a network, an indication of a transaction error;
determining, using electronically stored transaction rules and data, a classification of the transaction error based at least in part on the received indication of the transaction error;
presenting a transaction associated with the error to a user for one or more errors that are classified as a human error;
presenting the transaction associated with the error to a user for one or more errors that are classified as an external system error, to perform at least one of:
retracting an offer associated with the transaction; and
changing an offer associated with the transaction; and
providing a notification to an external system for one or more errors that are classified as an external system error.

2. The method of claim 1, further comprising classifying an error as requiring handling by a specified group in the event the received indication of the transaction error matches one or more transaction rules; and
assigning a transaction associated with the error to an electronic work queue of the specified group.

3. The method of claim 1, further comprising resubmitting a transaction for processing at a specified time in the event an error is classified as a connectivity error.

4. The method of claim 1, further comprising:
tracking a status of an electronic work queue containing one or more transactions for a user.

5. The method of claim 4, further comprising:
providing a user interface for a supervisor allowing viewing of electronic work queues of one or more supervised users.

6. The method of claim 5, providing a user interface control allowing reassignment of one or more transactions from a first user to a second user.

7. The method of claim 5, providing a user interface allowing generation and transmission of a reminder notification from a supervisor to a user.

8. The method of claim 1, wherein the external system comprises a billing system.

9. The method of claim 1, wherein the external system comprises a network provisioning system.

10. The method of claim 1, further comprising:
monitoring a status of a network accessible system; and
controlling a resubmission of one or more transactions based at least in part the monitored status of the network accessible system.

11. The method of claim 10, wherein controlling a resubmission of one or more transactions comprises submitting a transaction to the network accessible system when a status of the network accessible system meets one or more specified criteria.

12. The method of claim 10, wherein controlling a resubmission of one or more transactions comprises delaying a submission of a transaction when a status of the network accessible system meets one or more specified criteria.

13. The method of claim 1, further comprising:
providing an escalation workflow for one or more transactions.

14. The method of claim 13, wherein the escalation workflow provides at least one of:
electronic routing of transactions to supervisor work queues for approval; and
routing of transactions to supervisor work queues after a specified period of time.

15. The method of claim 1, wherein the electronically stored transaction rules and data are configurable to allow modification of routing and handling of errors.

16. A non-transitory computer readable storage medium comprising code to perform the acts of the method of claim 1.

17. A system, comprising:
a network element, wherein the network element comprises one or more processors configured to:
receive, via a network, an indication of a transaction error;
determine, using electronically stored transaction rules and data, a classification of the transaction error based at least in part on the received indication of the transaction error;
provide a notification to an external system for one or more errors that are classified as an external system error;
a first user interface to present a transaction associated with the error to a user for correction for one or more errors that are classified as human errors;
a second user interface present the transaction associated with the error to a user for one or more errors that are classified as external system errors, to perform at least one of:
retracting an offer associated with the transaction; and
changing an offer associated with the transaction.

18. A computer program product comprising a non-transitory computer-readable storage medium having computer-readable instructions stored therein, wherein the computer-readable instructions are configured to be readable from the at least one medium by at least one computer processor and thereby cause the at least one computer processor to operate so as to:
receive, via a network, an indication of a transaction error;
determine, using electronically stored transaction rules and data, a classification of the transaction error based at least in part on the received indication of the transaction error;
present a transaction associated with the error to a user for correction for one or more errors that are classified as human errors;
present the transaction associated with the error to a user for one or more errors that are classified as external system errors, to perform at least one of:
retracting an offer associated with the transaction; and
changing an offer associated with the transaction; and
provide a notification to an external system for one or more errors that are classified as external system errors.

19. The computer program product of claim 18, wherein the instructions are further configured to cause the at least one computer processor to operate so as to:
track a status of an electronic work queue containing one or more transactions for a user.

20. The computer program product of claim 18, wherein the instructions are further configured to cause the at least one computer processor to operate so as to:
provide a user interface for a supervisor allowing viewing of electronic work queues of one or more supervised users.
